(19) United States
(12) Patent Application Publication
(10) Pub. No.: US 2009/0266207 A1
(43) Pub. Date: Oct. 29, 2009

(54) SAFETY DEVICE FOR MACHINE TOOL

(76) Inventors: CHIH-HUI CHIU, Wujie Township (TW); JUN-DA WU, Jhongli City (TW); BO-JYUN SIAO, Taoyuan City (TW)

Correspondence Address: LEONG C LEI, PMB # 1008, 1867 YGNACIO VALLEY ROAD, WALNUT CREEK, CA, 94598, US

(21) Appl. No.: 12/108,532

(22) Filed: Apr. 24, 2008

(51) Int. Cl. B26D 7/24; F16D 27/00; F16P 3/12

(52) U.S. Cl. 83/61; 192/21.5; 83/526; 83/58

(57) ABSTRACT

The safety device mainly contains a main controller, a detector, and an emergency braking member. The main controller contains a detection member connecting the detector, an alarm member producing visual or audible alarm, and a driving member for activating the emergency braking member to reverse or stop the motor of the machine tool. The detection member could be an electrostatic detection unit, or a capacitance detection unit, or a combination of the two. The detector is positioned on a top surface of a platform and in front of a saw of the machine tool. The detector could also be part of an axle of the saw so that the saw is effectively an extension of the detector and provides both cutting and safety functions.

### TECHNICAL FIELD OF THE INVENTION

The present invention generally relates to machine tools, and more particularly to a device for enhancing the safety in operating the machine tool.

### DESCRIPTION OF THE PRIOR ART

For various machines tools, sawing machines are the most common ones that cause injuries to not only novice workers but also professional operators.

U.S. Pat. No. 7,05,417 provides a safety device for machine tools. The operation flow of the safety device is shown in FIG. 8. As illustrated, the saw band or saw plate is endowed with electrical charges. As human body is in effect a conductor, the electrical charges on the saw band or saw plate is discharged when it is in contact with human body. By detecting the occurrence of discharging, various safety mechanisms could be engaged such as moving the saw plate away or triggering a braking means.

This teaching has a number of disadvantages. First, the endowment of electrical charges makes the machine tool's usage more complicated and troublesome. Secondly, the braking means usually would damage the saw and a new set of saw has to be reinstalled, contributing a higher cost. And, thirdly, some minor injury to the worker or operator is still inevitable.

### SUMMARY OF THE INVENTION

Accordingly, a novel safety device is provided herein so as to obviate the foregoing shortcomings of the conventional approaches.

The safety device mainly contains a main controller, a detector, and an emergency braking member. The main controller contains a detection member connecting the detector, an alarm member producing visual or audible alarm, and a driving member for activating the emergency braking member to reverse or stop the motor of the machine tool.

The detection member could be an electrostatic detection unit, or a capacitance detection unit, or a combination of the two. The detector is positioned on a top surface of a platform and in front of a saw of the machine tool. The detector could also be part of an axle of the saw so that the saw is effectively an extension of the detector and provides both cutting and safety functions.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing the various components of the safety device of the present invention.

FIG. 2 is a schematic diagram showing a way of arranging the detector of the safety device of the present invention on a machine tool.

FIG. 3 is a schematic diagram showing another way of arranging the detector of the safety device of the present invention on a machine tool.

FIGS. 4 and 5 show an operation scenario of a machine tool with a safety device of the present invention.

FIG. 6 is a flow diagram showing the operation of the safety device according to the present invention.

FIG. 7 is a schematic diagram showing an embodiment of the detector of the safety device of the present invention.

FIG. 8 is a flow diagram showing the operation of a conventional machine tool safety device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

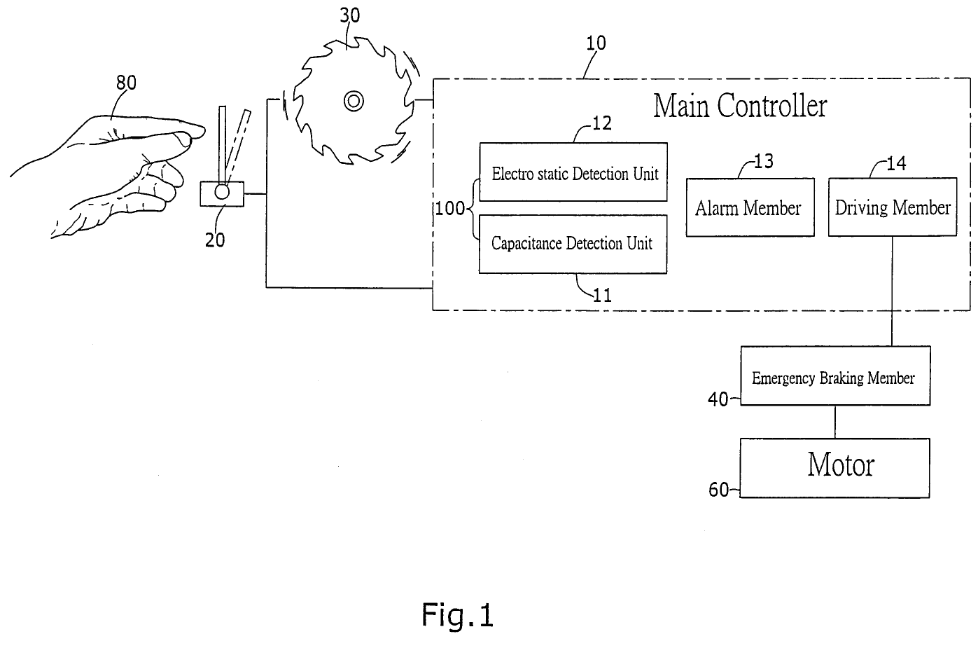

As shown in FIG. 1, a safety device according to the present invention mainly contains a main controller 10, a detector 20, and an emergency braking member 40.

The main controller 10 contains a detection member 100, an alarm member 13, and a driving member 14. The detection member 100 could be an electrostatic detection unit 12, or a capacitance detection unit 11, or a combination of the two. The electrostatic sensing unit 12 is coupled with the detector 20 through a Darlington interface (not shown) and is connected to ground (not shown). The electrostatic sensing unit 12 is configured with a reference level (the reference level could be varied in different applications). Once the detector 20 detects an electrical charge exceeding the reference level (e.g., it is touched by a person carrying electrostatic charge), the electrostatic detection unit 12 would trigger the main controller 10. On the other hand, the capacitance detection unit 11 detects a capacitance value of the detector 20 and, if required, triggers the main controller 10 (more details will be given later).

The detection member 100 could be one of the electrostatic detection unit 12 and the capacitance detection unit 11. If both are used, the safety device of the present invention could provide an enhanced sensitivity.

The alarm member 13 could be a lamp (e.g., light emitting diode, LED) that produces visual alarm or a speaker that produces audible alarm.

The driving member 13 is for engaging the emergency braking member 40.

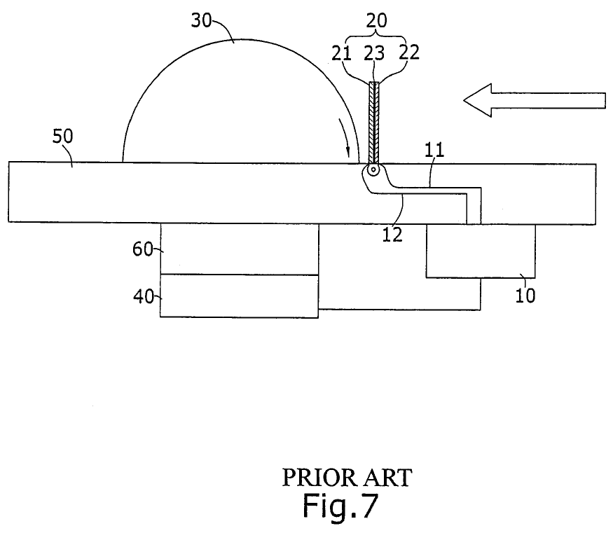

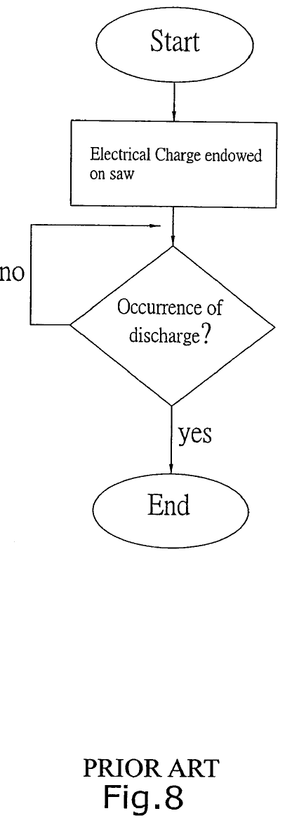

In one embodiment of the present invention as shown in FIG. 7, the detector 20 contains a dielectric layer 23 sandwiched between two conductor layers 21 and 22, which are connected to the electrostatic detection unit 11 and the capacitance detection unit 12. As such, when a finger 80 of an operator touches the detector 20, electrostatic charges are transferred to the detector 20 and the capacitance value of the detector 20 is varied as well. These changes are immediately picked up by the electrostatic detection unit 12 and the capacitance detection unit 11. The main controller 10 could further give different weight to the signals picked up by the electrostatic detection unit 12 and the capacitance detection unit 11 so as to achieve even more accurate judgment about whether an emergency has occurred.

The emergency braking member 40 could be any appropriate means to stop the motor 60 or to turn the motor 60 in a reversed direction.

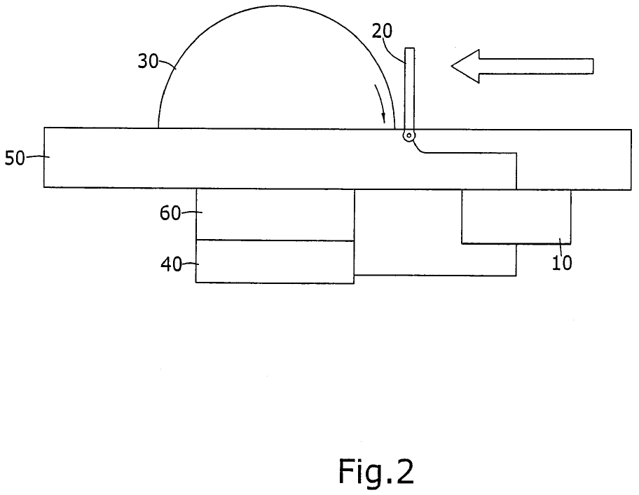

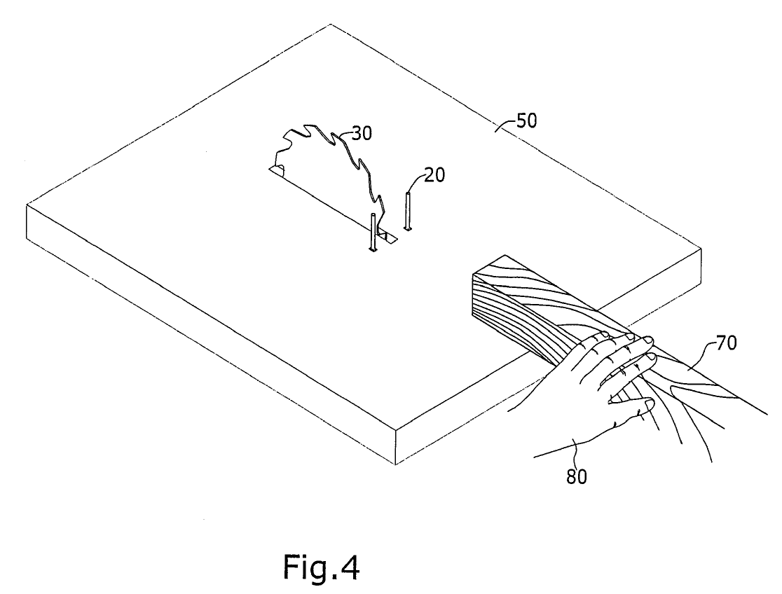

FIGS. 2 and 4 show an application of the safety device on a sawing machine. As illustrated, the main controller 10 is positioned beneath a platform 50 of the sawing machine, and at least a pole-shaped metallic detector 20 is positioned on a top surface of the platform 50 and in front of the saw 30. Preferably, two detectors 20 are arranged to both sides of the saw 30, respectively.

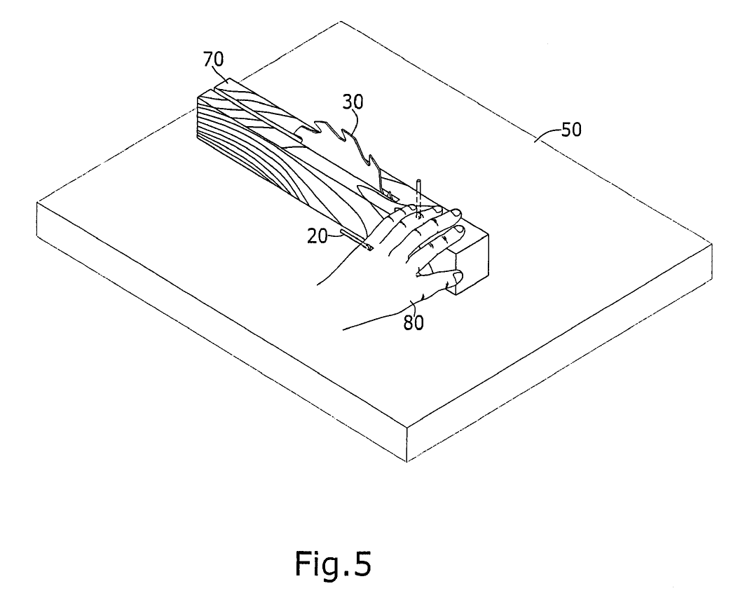

When a piece of wood 70 is moved towards the saw 30, non-conductors such as the piece of wood 70 would not affect the detector 20. However, as shown in FIG. 5, when an operator's finger 80 touches the detector 20, the driving member 14 of the main controller 10 activates the emergency braking member 40, which in turn immediately stops the motor 60 and the saw 30. In the mean time, the alarm member 13 could be turned on to produce visual or audible alarms.

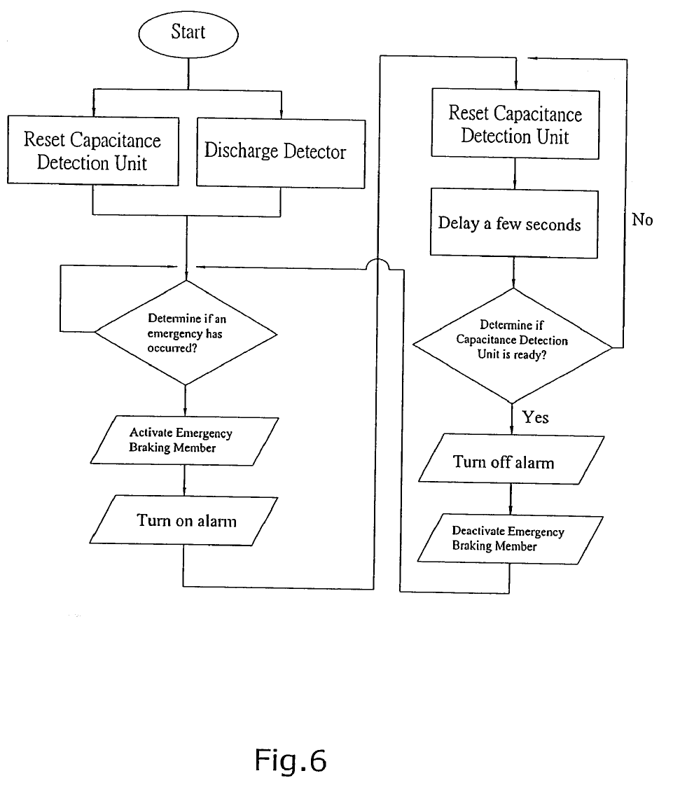

The operation of the main controller 10 is depicted in greater details in a flow chart shown in FIG. 6. As illustrated, when the main controller 10 is started, it first releases the charges on the detector 20, set a reference level to the electrostatic detection unit 12, and/or resets the capacitance detection unit 11. Then, the main controller 10 continuously monitors the electrostatic detection unit 12 and the capacitance detection unit 11. Once the main controller 10 is triggered, the driving member 14 is invoked to activate the emergency braking member 40 to reverse or stop the motor 60. The alarm member 13 is then turned on to deliver visual or audible alarm. Subsequently, the capacitance detection unit 11 is reset and the main controller 10 waits a few seconds (e.g., 3 seconds). The reset process is repeated, if required, until the capacitance detection unit 11 is ready again. The main controller 10 then turns off the alarm member 13 and deactivates the emergency braking member 40 so that the motor 60 could resume its normal operation.

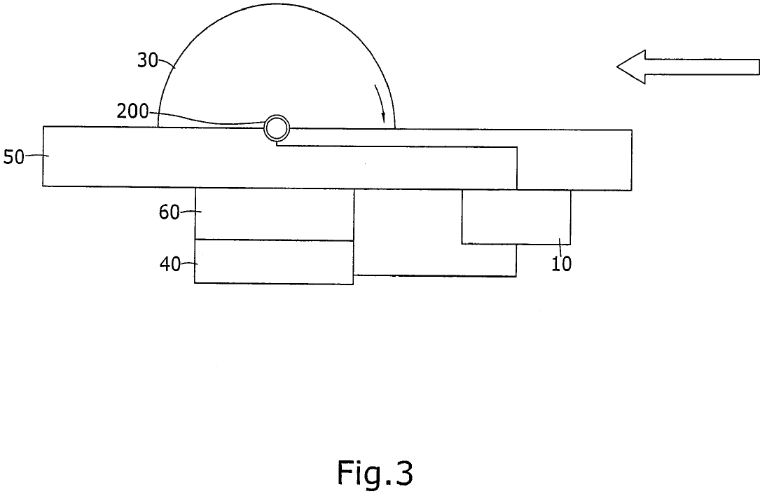

In the foregoing embodiments, the detector 20 is a metallic pole separated from the saw 30. In an alternative embodiment shown in FIG. 3, the detector 20 could be part of an axle 200 of the saw 30. In other words, the saw 30 is effectively an extension of the detector 20 and provides both cutting and safety functions. The two approaches could be jointly implemented on the same machine tool so as to provide double protection.

The present invention has a number of advantages. First, there is no need to inject electrical charges onto the saw, making the machine tool more convenient to use. Secondly, the safety device stops or reverses the motor to protect the operator without damaging the saw, which makes the safety device more economical. Thirdly, the safety device has the detector positioned in front of the saw, giving more time for the emergency braking member and the operator as well to respond and thereby reducing the possibility of injury to a minimum. In addition, the safety device could provide multiple detection mechanisms such as those shown in FIGS. 2 and 3 so that the machine tool is significantly more secured to operate.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A safety device for a machine tool, comprising:
an emergency braking member, when activated, reversing or stopping a motor of said machine tool;
at least a detector;
a main controller having a detection member connected to said detector, an alarm member, and a driving member for activating said emergency braking member;
wherein said detector is capable of sensing an electrostatic charge of an object contacting said detector; said detection member is an electrostatic detection unit having a reference level; and, when said detector detects an electrostatic charge above said reference level, said electrostatic detection unit triggers said main controller to activate said emergency braking member via said driving member.

2. The safety device according to claim 1, wherein said alarm member is one of a lamp and a speaker.

3. The safety device according to claim 1, wherein said electrostatic detection unit is connected to ground.

4. A safety device for a machine tool, comprising:
an emergency braking member, when activated, reversing or stopping a motor of said machine tool;
at least a detector;
a main controller having a detection member connected to said detector, an alarm member, and a driving member for activating said emergency braking member;
wherein said detection member is a capacitance detection unit detecting a capacitance value of said detector; and, when said detector has an abnormal capacitance value, said capacitance detection unit triggers said main controller to activate said emergency braking member via said driving member.

5. The safety device according to claim 4, wherein said alarm member is one of a lamp and a speaker.

6. A safety device for a machine tool, comprising:
an emergency braking member, when activated, reversing or stopping a motor of said machine tool;
at least a detector;
a main controller having a detection member connected to said detector, an alarm member, and a driving member for activating said emergency braking member;
wherein said detector is capable of sensing an electrostatic charge of an object contacting said detector; said detection member contains an electrostatic detection unit having a reference level and a capacitance detection unit detecting a capacitance value of said detector; and, when said detector detects an electrostatic charge above said reference level and/or said detector has an abnormal capacitance value, said electrostatic detection unit and said capacitance detection unit trigger said main controller to activate said emergency braking member via said driving member.

7. The safety device according to claim 6, wherein said alarm member is one of a lamp and a speaker.

8. The safety device according to claim 6, wherein said electrostatic detection unit is connected to ground.

9. A machine tool, comprising:
a platform, a saw exposing from a top surface of said platform, and a motor driving said saw;
an emergency braking member, when activated, reversing or stopping said motor;
at least a detector;
a main controller having a detection member connected to said detector, an alarm member, and a driving member for activating said emergency braking member;
wherein said detector is capable of sensing an electrostatic charge of an object contacting said detector; said detection member is an electrostatic detection unit having a reference level; and, when said detector detects an electrostatic charge above said reference level, said electrostatic detection unit triggers said main controller to activate said emergency braking member via said driving member.

10. The machine tool according to claim 9, wherein said detector is positioned on said top surface of said platform in front of said saw.

11. The machine tool according to claim 9, wherein said detector is pole-shaped and made of a metallic material.

12. The machine tool according to claim 9, wherein said detector is part of an axle of said saw.

13. A machine tool, comprising:
a platform, a saw exposing from a top surface of said platform, and a motor driving said saw;
an emergency braking member, when activated, reversing or stopping said motor;
at least a detector;
a main controller having a detection member connected to said detector, an alarm member, and a driving member for activating said emergency braking member;
wherein said detection member is a capacitance detection unit detecting a capacitance value of said detector; and, when said detector has an abnormal capacitance value, said capacitance detection unit triggers said main controller to activate said emergency braking member via said driving member.

14. The machine tool according to claim 13, wherein said detector is positioned on said top surface of said platform in front of said saw.

15. The machine tool according to claim 13, wherein said detector is pole-shaped and made of a metallic material.

16. The machine tool according to claim 13, wherein said detector is part of an axle of said saw.

17. The machine tool according to claim 13, wherein there are two detectors with a first detector positioned on said top surface of said platform in front of said saw and a second detector being part of an axle of said saw.

18. A machine tool, comprising:
a platform, a saw exposing from a top surface of said platform, and a motor driving said saw;
an emergency braking member, when activated, reversing or stopping said motor;
at least a detector;
a main controller having a detection member connected to said detector, an alarm member, and a driving member for activating said emergency braking member;
wherein said detector is capable of sensing an electrostatic charge of an object contacting said detector; said detection member contains an electrostatic detection unit having a reference level and a capacitance detection unit detecting a capacitance value of said detector; and, when said detector detects an electrostatic charge above said reference level and/or said detector has an abnormal capacitance value, said electrostatic detection unit and said capacitance detection unit trigger said main controller to activate said emergency braking member via said driving member.

19. The machine tool according to claim 18, wherein said detector is positioned on said top surface of said platform in front of said saw.

20. The machine tool according to claim 18, wherein said detector is pole-shaped and made of a metallic material.

21. The machine tool according to claim 18, wherein said detector is part of an axle of said saw.

22. The machine tool according to claim 18, wherein there are two detectors with a first detector positioned on said top surface of said platform in front of said saw and a second detector being part of an axle of said saw.

23. The machine tool according to claim 18, wherein said detector comprising a dielectric layer sandwiched between two conductor layers.
